(19) United States
(12) Patent Application Publication
(10) Pub. No.: US 2021/0031393 A1
(43) Pub. Date: Feb. 4, 2021

(54) ULTRASONIC CUTTING METHOD EMPLOYING STRAIGHT-BLADE SHARP KNIFE AND APPLICATION THEREOF

(71) Applicant: DALIAN UNIVERSITY OF TECHNOLOGY, Dalian, Liaoning (CN)

(72) Inventors: Zhigang DONG, Dalian, Liaoning (CN); Renke KANG, Dalian, Liaoning (CN); Yidan WANG, Dalian, Liaoning (CN); Xianglong ZHU, Dalian, Liaoning (CN); Xuanping WANG, Dalian, Liaoning (CN); Shang GAO, Dalian, Liaoning (CN); Zhenyuan JIA, Dalian, Liaoning (CN)

(21) Appl. No.: 16/968,124

(22) PCT Filed: Feb. 2, 2019
(86) PCT No.: PCT/CN2019/074604

§ 371 Date: Aug. 6, 2020

(30) Foreign Application Priority Data
Feb. 24, 2018 (CN) 201810157222.2
Feb. 24, 2018 (CN) 201810157260.8
Feb. 24, 2018 (CN) 201810157492.3
Mar. 7, 2018 (CN) 201810186537.X

(51) Int. Cl. B26D 1/00; B26D 7/08

(52) U.S. Cl. CPC B26D 1/0006; B26D 1/245; B26D 7/086

(57) ABSTRACT

Disclosed is an ultrasonic cutting method employing a straight-blade sharp knife. The ultrasonic cutting method employing the straight-blade sharp knife includes the following steps: S1, measuring parameters of the straight-blade sharp knife; S2, initially rotating, by the straight-blade sharp knife, around an axis thereof, such that a rear knife surface of the straight-blade sharp knife is attached to or is away from a machined surface, and performing ultrasonic vibration cutting on a material according to a machining track; S3, performing quality detection on the machined material surface obtained by the ultrasonic vibration cutting, completing the machining if the surface passes the detection, and performing step S4 if the surface does not pass the detection; S4, further increasing an amount of rotation of the straight-blade sharp knife during initial rotation around the axis thereof, performing the ultrasonic vibration cutting on the material according to the machining track, and performing step S3.

### FIELD OF TECHNOLOGY

The present invention relates to the field of machining technical control, and in particular to an ultrasonic cutting method employing a straight-blade sharp knife and an application thereof.

### BACKGROUND

The ultrasonic straight-blade sharp knife is a special machining knife applied to fields such as food cutting and cutting of composite materials (such as carbon fibers or aramid fibers). The knife body is generally of the flaky shape, and has the sharp cutting blade. Under the driving of the ultrasonic vibration system, the knife generates high-frequency vibration in a range of 20 kHz to 40 kHz axially during machining; and meanwhile, the knife is fed along a specified path. Since the knife has a certain thickness, while the knife enters the material by cutting, two sides of the blade extrude the material laterally. The material is cut under the action of ultrasonic vibration and lateral extrusion of the blade. With the ultrasonic-frequency vibration, the knife may cut the material more easily, the cutting force of the knife in the feed direction is reduced, and the machining precision is improved. However, as the straight-blade sharp knife has the certain thickness, it is inevitable for the ultrasonic straight-blade sharp knife to extrude the material on two sides of the cutting seam. Because the machined material is the flexible plastic material, such an extrusion action will cause crushing deformation on the machined surface, thus affecting adhesive performance, mechanical performance and the like of the material. With the honeycomb core material cut by the ultrasonic straight-blade sharp knife as an example, the crushing deformation on the surface has a direct impact on the machining quality.

### SUMMARY

According to the above technical problem, the present invention provides an ultrasonic cutting method employing a straight-blade sharp knife and an application thereof. The technical means used by the present invention is as follows:

An ultrasonic cutting method employing a straight-blade sharp knife includes the following steps:

S1, measuring parameters of the straight-blade sharp knife;

S2, initially rotating, by the straight-blade sharp knife, around an axis thereof, such that a rear knife surface of the straight-blade sharp knife is attached to or is away from a machined surface, thus reducing an extrusion action of the rear knife surface of the straight-blade sharp knife to the machined surface, and transferring most of an extrusion force to a side of a cutting chip; and performing ultrasonic vibration cutting on a material according to a machining track;

S3, performing quality detection on the machined material surface obtained by the ultrasonic vibration cutting, completing the machining if the surface passes the detection, and performing step S4 if the surface does not pass the detection; and

S4, further increasing an amount of rotation (a rotating angle) of the straight-blade sharp knife during initial rotation around the axis thereof, performing the ultrasonic vibration cutting on the material according to the machining track, and performing step S3.

The parameters of the straight-blade sharp knife include a half-wedge angle ε, a half-nose angle δ and a knife rake angle θ.

The half-wedge angle ε is a half of an included angle between the front knife surface and the rear knife surface within the knife working plane.

The knife rake angle θ is the line-plane angle formed between the axis and the plane perpendicular to the feed direction.

The half-nose angle δ is an included angle between the blade and the axis within the knife central plane.

The relief angle is an angle formed between the rear knife surface and the cutting plane within the orthogonal plane.

In step S2, before initially rotating, by the straight-blade sharp knife, around the axis thereof, calculating a knife rotating angle λ₀ rotated by the straight-blade sharp knife is included, with a following calculation process:

in a space rectangular coordinate system, giving an equivalent relief angle of the straight-blade sharp knife by using a rotation matrix method, the equivalent relief angle of the straight-blade sharp knife being a function regarding the knife rake angle θ, the half-wedge angle ε, the half-nose angle δ and the knife rotating angle λ; and in a case where the knife rake angle θ, the half-wedge angle ε and the half-nose angle δ are determined, solving, by using mathematical software Matrix Laboratory (MATLAB), the knife rotating angle λ, i.e., the knife rotating angle λ₀ rotated by the straight-blade sharp knife, when the equivalent relief angle of the straight-blade sharp knife is 0°, when an initial rotating angle of the straight-blade sharp knife around the axis thereof is equal to λ₀, the rear knife surface of the straight-blade sharp knife being attached to the machined surface, and when the initial rotating angle of the straight-blade sharp knife around the axis thereof is greater than λ₀, the rear knife surface of the straight-blade sharp knife being away from the machined surface.

In step S1, the parameters of the straight-blade sharp knife are measured by a photoelectric sensor.

An angle between the rear knife surface of the straight-blade sharp knife and the machined surface is constant during the ultrasonic vibration cutting performed on the material according to the machining track: if the machining track is a straight line, the initial rotating angle of the straight-blade sharp knife around the axis thereof keeps unchanged all the time during the ultrasonic vibration cutting; and if the machining track is a curved line, the rotation of the straight-blade sharp knife around the axis thereof is adjusted according to the machining track, such that the angle between the rear knife surface of the straight-blade sharp knife and the machined surface is constant during the ultrasonic vibration cutting.

The straight-blade sharp knife includes a threaded segment, a stiffness reinforcement block, a trapezoid table-like transition block and a flaky open knife body that are connected sequentially, and axes of the threaded segment, the stiffness reinforcement block, the trapezoid table-like transition block and the flaky open knife body are all located on the axis of the straight-blade sharp knife, thus ensuring that the ultrasonic vibration is longitudinally transferred to a following cutting arc bottom blade along the axis of the straight-blade sharp knife.

The stiffness reinforcement block has the effect of reinforcing the stiffness of the straight-blade sharp knife, and is in smooth transition with the flaky open knife body via the trapezoid table-like transition block; and in a process when ultrasonic energy is transferred axially along the straight-blade sharp knife, as the sectional area of the straight-blade sharp knife decreases stably, the ultrasonic energy increases stably with the decrease of the sectional area in transmission, and at last, the relatively large amplitude is output at the following cutting arc bottom blade.

A big end of the trapezoid table-like transition block is connected to a front end of the stiffness reinforcement block, the big end of the trapezoid table-like transition block is consistent with the front end of the stiffness reinforcement block in size, a small end of the trapezoid table-like transition block is connected to a rear end of the flaky open knife body, the small end of the trapezoid table-like transition block is consistent with the rear end of the flaky open knife body in size, and an outer wall located between the big end of the trapezoid table-like transition block and the small end of the trapezoid table-like transition block is in arc transition from the big end of the trapezoid table-like transition block to the small end of the trapezoid table-like transition block; and with the arc transition structure, the stress concentration under the ultrasonic action is prevented, and the service life of the knife under the ultrasonic action is improved.

An outer surface of the flaky open knife body is an arc surface, the front end of the flaky open knife body is provided with the cutting arc bottom blade constituted by a sector-ring arc front knife surface and a fan-ring arc rear knife surface, the cutting arc bottom blade tilts to the outer surface of the flaky open knife body (to reduce the friction between the fan-ring arc rear knife surface and the machined honeycomb core material surface), and two sides of the flaky open knife body are respectively provided with a side blade extending from a rear end of the flaky open knife body to the cutting arc bottom blade; and the outer surface of the flaky open knife body is the rear knife surface of the straight-blade sharp knife.

A guide groove extending from a rear end of the stiffness reinforcement block to the cutting arc bottom blade is provided on an inner surface of the straight-blade sharp knife, the guide groove includes a stiffness reinforcement block guide groove located on an inner surface of the stiffness reinforcement block, a trapezoid table-like transition block guide groove located on an inner surface of the trapezoid table-like transition block and an arc knife body guide groove located on an inner surface of the flaky open knife body, and the arc knife body guide groove corresponds to the outer surface of the flaky open knife body.

The straight-blade sharp knife is bilaterally symmetric; and the outer surface of the flaky open knife body, the cutting arc bottom knife and the guide groove are all bilaterally symmetric with regard to a symmetry plane that passes through the axis of the straight-blade sharp knife and is perpendicular to the inner surface of the straight-blade sharp knife.

The fan-ring arc front knife surface and the fan-ring arc rear knife surface are respectively located on two coaxial tapered surfaces (i.e., the two tapered surfaces are formed into a trumpet shape), the outer surface of the flaky open knife body and the arc knife body guide groove are respectively located on two coaxial cylindrical surfaces, and when the two tapered surfaces and the two cylindrical surfaces are coaxial and have axes sufficiently away from the straight-blade sharp knife, the fan-ring arc front knife surface, the fan-ring arc rear knife surface, the outer surface of the flaky open knife body and the arc knife body guide groove tend to be a plane.

An arc where a nose (at an intersection between the fan-ring arc front knife surface and the fan-ring arc rear knife surface) of the cutting arc bottom knife is located has a central angle of greater than 0° and smaller than 360°.

When the straight-blade sharp knife is used to machine a curve outline of a honeycomb core, according to honeycomb core machining requirements of curve outlines having different curvature radii, the arc where the nose of the cutting arc bottom knife is located has a radius of smaller than or equal to a minimum curvature radius of the curve outline of the honeycomb core that needs to be machined; and for cutting of internal and external curve outlines of the honeycomb core, the cutting knife has different orientations, and needs to be adjusted around an own axis in rotating angle: when the external outline of the honeycomb core is machined, a cylindrical surface where the nose of the cutting arc bottom blade is located is externally tangent to a path of the curve outline that is required to be machined; when the internal curve outline of the honeycomb core is machined, a cylindrical surface where the nose of the cutting arc bottom blade is located is internally tangent to a path of the curve outline that is required to be machined; after an angle of the knife is adjusted, the knife is fed axially to cut a honeycomb core material; and through cutting by a series of small segments, the outline approaches to the required curve outline.

A front angle of the cutting arc bottom blade is 45-85°, a relief angle of the cutting arc bottom blade is 0-15°, and a wedge angle of the cutting arc bottom blade is 5-30°.

The rake angle of the cutting arc bottom blade refers to an included angle between the fan-ring arc front knife surface and the perpendicular surface of the sidewall of the honeycomb core curve outline within the symmetry plane, and is configured to make the cutting blade cut a workpiece material smoothly, and guide the cutting chip smoothly.

The relief angle of the cutting arc bottom blade refers to an included angle between the fan-ring arc rear knife surface and the sidewall of the curve outline of the honeycomb core (i.e., the included angle with the axis of the straight-blade sharp knife) within the symmetry plane, such that while the knife body performs the cutting, the extrusion and scratch to a material on the sidewall of the outline of the honeycomb core are prevented.

The wedge angle of the cutting arc bottom blade refers to an included angle between the fan-ring arc front knife surface and the fan-ring arc rear knife surface within the symmetry plane, and is configured to improve the stiffness of the knife cutting blade portion.

An axial kidney groove is provided along an axial direction of the straight-blade sharp knife and on a bottom proximal to the cutting arc bottom blade in the arc knife body guide groove, and the axial kidney groove penetrates through the flaky open knife body. The axial kidney groove is provided to change the path that the ultrasonic energy is propagated on the straight-blade sharp knife, and absorb transverse vibration energy generated by the ultrasonic action on the straight-blade sharp knife, such that the vibration energy is propagated axially.

A width of the flaky open knife body is designed according to a size of a honeycomb core grid, and a length of the flaky open knife body is greater than a depth of a honeycomb core in need of being cut.

After the straight-blade sharp knife is fed along the axis to ultrasonically cut the honeycomb core, a cutting seam kept by the flaky open knife body on the honeycomb core is 0.5-5 mm wide.

The straight-blade sharp knife is made of hard alloy or high-speed steel to obtain the better ultrasonic vibration effect, and the cutting arc bottom blade and the side blade are subjected to coating treatment to reduce the wear.

The straight-blade sharp knife applies the ultrasonic vibration in the axial direction, and is fed axially to cut the honeycomb core material, and the rotating angle is adjusted on a safety plane after withdrawal of the honeycomb core. The straight-blade sharp knife may cut the honeycomb core material smoothly under the ultrasonic action, and the cutting arc bottom blade further reduces the friction with the honeycomb core machined surface under the ultrasonic action, thereby reducing the honeycomb core machining defect, reducing the wear of the knife, prolonging the service life of the knife, and implementing the high-quality machining for the outline of the honeycomb core.

An ultrasonic cutting method for a honeycomb core sinking groove structure includes the following steps:

A1, outline forming: cutting, by using a slotting knife and a straight-blade sharp knife, an outline of the honeycomb core sinking groove structure under an action of ultrasonic vibration, an ultrasonic dicing method of the straight-blade sharp knife being the above-mentioned ultrasonic cutting method employing the straight-blade sharp knife;

A2, dicing division: in combination with a diameter of a circular slicing knife and an edge length of a to-be-machined honeycomb core, according to a shape and a size of the honeycomb core sinking groove structure, ultrasonically dicing an internal material of the honeycomb core sinking groove structure by using the straight-blade sharp knife according to a dicing track, to divide the internal material into a blocky or strip-shaped cutting chip;

A3, removal for the internal material of the honeycomb core sinking groove structure: ultrasonically dicing the internal material of the honeycomb core sinking groove structure layer by layer by using the circular slicing knife for removal; and

A4, precision machining for a bottom of the honeycomb core sinking groove structure: ultrasonically slicing a remaining machining allowance by using the circular slicing knife to obtain the high-quality bottom of the honeycomb core sinking groove structure, thus completing the machining of the honeycomb core sinking groove structure.

During the outline forming, an axis of the straight-blade sharp knife is in a tilted status, an arc outline of the honeycomb core sinking groove structure is machined through plunge milling by using the slotting knife, and then the rest outline of the honeycomb core sinking groove structure is ultrasonically diced by using the straight-blade sharp knife having the axis in the tilted status.

The dicing track includes a plurality of transverse and longitudinal dicing lines.

During the dicing division, the axis of the straight-blade sharp knife is in a perpendicular status, and a cutting allowance in a horizontal direction is respectively kept between two ends of the dicing line and the corresponding outline of the honeycomb core sinking groove structure.

Or during the dicing division, the axis of the straight-blade sharp knife is in the tilted status, a starting end of the dicing line is located on the corresponding outline of the honeycomb core sinking groove structure, a cutting allowance in a horizontal direction is kept between the other end of the dicing line and the corresponding outline of the honeycomb core sinking groove structure, and the straight-blade sharp knife performs perpendicular cutting on the starting end of the dicing line, and is stopped and lifted when dicing to the other end of the dicing line.

The horizontal cutting allowance is smaller than or equal to the diameter of the circular slicing knife.

In step A2, a size of a single blocky or strip-shaped cutting chip is greater than the edge length a of the to-be-machined honeycomb core and smaller than the diameter D of the circular slicing knife, so as to ensure the cutting stiffness and cutting performance of the internal material of the honeycomb core sinking groove structure and remove the internal material smoothly in the form of the cutting chip; and a perpendicular machining allowance of 0.1-10 mm is preserved between a dicing depth of the straight-blade sharp knife and the bottom of the honeycomb core sinking groove structure, thus laying a foundation for the subsequent removal for the internal material of the honeycomb core sinking groove structure and the subsequent precision machining for the bottom of the honeycomb core sinking groove structure.

During the removal for the internal material of the honeycomb core sinking groove structure, the circular slicing knife vibrates ultrasonically while rotating, thus slicing the internal material of the honeycomb core sinking groove structure layer by layer from the inside out for removal.

Slicing each layer for removal includes the following steps:

cutting, by the circular slicing knife, the internal material of the honeycomb core sinking groove structure along a spiral track; and when cutting to a specified depth of each layer, performing ultrasonic cutting along a plane cutting track; removing the internal material of the honeycomb core sinking groove structure in the form of the strip-shaped or blocky cutting chip, thus completing the cutting of the internal material of the honeycomb core sinking groove structure on the layer; and circulating the process till rest internal material of the honeycomb core sinking groove structure is removed.

In step A4, ultrasonically slicing the remaining machining allowance by using the circular slicing knife refers to that the remaining machining allowance is sliced layer by layer for removal; and the remaining machining allowance is removed in the form of the flaky cutting chip, thus obtaining the high-quality cutting surface.

An ultrasonic cutting method for a honeycomb core lug boss structure includes the following steps:

B1, grid end-surface precision machining: performing precision machining on an end surface of a honeycomb core grid by using a circular slicing knife to obtain a high-quality cutting surface;

B2, outline forming: machining, by using a slotting knife and a straight-blade sharp knife successively, an outline of the honeycomb core lug boss structure under an action of ultrasonic vibration, a dicing method of the straight-blade sharp knife being the above-mentioned ultrasonic cutting method employing the straight-blade sharp knife;

B3, dicing division: in combination with a radius of the circular slicing knife and an edge length of a to-be-machined honeycomb core grid, according to a shape and a size of the honeycomb core lug boss structure, ultrasonically dicing an external material of the honeycomb core lug boss structure by using the straight-blade sharp knife according to a dicing track, to divide the external material into a block shape or a strip shape;

B4, removal for the external material of the honeycomb core lug boss structure: ultrasonically dicing the external material of the honeycomb core lug boss structure layer by layer by using the circular slicing knife for removal; and

B5, precision machining for a step surface of the honeycomb core lug boss structure: ultrasonically slicing a remaining machining allowance by using the circular slicing knife to obtain the high-quality step surface of the honeycomb core lug boss structure, thus completing the machining of the honeycomb core lug boss structure.

During the outline forming, a fillet outline of the honeycomb core lug boss structure is cut first under the action of the ultrasonic vibration by using the slotting knife, and then under the action of the ultrasonic vibration, the straight-blade sharp knife is used for dicing along the outline of the honeycomb core lug boss structure to dice a “#”-shaped outline by four times of cutting.

The dicing track includes a plurality of transverse and longitudinal dicing lines.

During the dicing division, an axis of the straight-blade sharp knife is in a tilted status, and the straight-blade sharp knife tilts to an external direction of the outline of the honeycomb core lug boss structure, thus ensuring that a blade of the straight-blade sharp knife is perpendicular to an end surface of the to-be-machined honeycomb core grid, and is fed downwards to a specified depth.

Or during the dicing division, the axis of the straight-blade sharp knife is in a perpendicular status, and when the straight-blade sharp knife dices to be proximal to the outline of the honeycomb core lug boss structure, a horizontal cutting allowance is kept, the horizontal cutting allowance being a half of a width of the straight-blade sharp knife.

In step B3, a size of a single blocky or strip-shaped cutting chip is greater than the edge length a of the to-be-machined honeycomb core grid and smaller than the radius R of the circular slicing knife, so as to ensure the cutting stiffness and cutting performance of the external material of the honeycomb core lug boss structure and remove the external material smoothly in the form of the cutting chip; and a perpendicular machining allowance of 0.1-10 mm is preserved between a dicing depth of the straight-blade sharp knife and the step surface of the honeycomb core lug boss structure, thus making a preparation for the subsequent removal for the external material of the honeycomb core lug boss structure and the subsequent precision machining for the step surface of the honeycomb core lug boss structure.

During the removal for the external material of the honeycomb core lug boss structure, the circular slicing knife vibrates ultrasonically while rotating, thus slicing the external material of the honeycomb core lug boss structure layer by layer from the outside in for removal.

Slicing each layer for removal includes the following steps:

selecting an appropriate slicing depth, the circular slicing knife slicing from an outermost end of the external material of the honeycomb core lug boss structure, performing ultrasonic cutting along the plane cutting track from the outside in, and removing the external material of the honeycomb core lug boss structure in the form of the strip-shaped or blocky cutting chip, thus completing the cutting of the external material of the honeycomb core lug boss structure on the layer; and circulating the process till rest external materials of honeycomb core lug boss structure are removed; and ensuring that a machining allowance of 2-5 mm is kept, thus making the preparation for a next step of the precision machining for the step surface of the honeycomb core lug boss structure.

In step B4, ultrasonically slicing the remaining machining allowance by using the circular slicing knife refers to that the remaining machining allowance is sliced layer by layer for removal; and the remaining machining allowance is removed in the form of the flaky cutting chip, thus obtaining the high-quality cutting surface.

Compared with the prior art, the present invention may effectively reduce the extrusion of the rear knife surface of the straight-blade sharp knife to the machined surface, thereby improving the surface machining quality of the material.

The ultrasonic action reduces the cutting force, the deformation of the honeycomb core grid and the damage of the honeycomb wall, and improves the machining quality and machining precision of the honeycomb core curve outline machining.

The straight-blade sharp knife provided by the present invention does not make the rotational movement in cutting feeding, and the rotating angle of the knife is adjusted on the safety plane after the withdrawal of the honeycomb core; and the straight-blade sharp knife may cut the honeycomb core material smoothly under the ultrasonic action, and the cutting arc bottom blade further reduces the friction with the honeycomb core machined surface under the ultrasonic action, thereby reducing the honeycomb core machining defect, reducing the wear of the knife, prolonging the service life of the knife, and implementing high-quality machining for the outline of the honeycomb core.

The flaky open knife body can reduce the damage to the honeycomb core structure proximal to the machined curve outline, and solve the problem that the stiffness of the honeycomb core is reduced due to the machining to result in that the material in the next step is cut difficultly, and the cutting surface has the poor quality.

The flaky open knife body solves the problem that the traditional cylindrical outline cutting knife is hard to remove the chip and dissipate the heat.

The width of the flaky open knife body is designed according to the size of the honeycomb core grid, and the length of the flaky open knife body is greater than the depth of the honeycomb core in need of being cut, such that the damage to the honeycomb core grid at the knife connection place can be effectively prevented, and the machining quality of the machining curve outline of the honeycomb core is improved.

The present invention may be widely applied to the fields such as machining technical control based on the above reasonings.

### BRIEF DESCRIPTION OF THE DRAWINGS

In order to describe the technical solutions in the embodiments of the present invention or in the prior art more clearly, a simple introduction on the accompanying drawings which are needed in the description of the embodiments or prior art is given below. Apparently, the accompanying drawings in the description below are merely some of the embodiments of the present invention, based on which other drawings may be obtained by those of ordinary skill in the art without any creative effort.

FIG. 1 is a schematic diagram of parameters of a straight-blade sharp knife in Embodiment 1 of the present invention.

FIG. 2 is a schematic diagram of rotation of a straight-blade sharp knife in Embodiment 1 of the present invention.

FIG. 3 is a schematic diagram of a straight-blade sharp knife placed in a space rectangular coordinate system in Embodiment 1 of the present invention.

FIG. 4 is a schematic diagram of a change of a relief angle of a straight-blade sharp knife with a rotating angle of the straight-blade sharp knife around an axis thereof in Embodiment 1 of the present invention.

FIG. 5 is a schematic diagram (front view) of ultrasonic vibration cutting in Embodiment 1 of the present invention.

FIG. 6 is a schematic diagram (side view) of ultrasonic vibration cutting in Embodiment 1 of the present invention.

FIG. 7 is a schematic diagram (top view) of ultrasonic vibration cutting in Embodiment 1 of the present invention.

FIG. 8 is a machined surface obtained by common cutting.

FIG. 9 is a machined surface obtained by Embodiment 1 of the present invention.

FIG. 10 is a front view of a straight-blade sharp knife in Embodiment 2 of the present invention.

FIG. 11 is a sectional view in an A-A direction in FIG. 10.

FIG. 12 is a three-dimensional structural schematic diagram of a straight-blade sharp knife in Embodiment 2 of the present invention.

FIG. 13 is a front view of a straight-blade sharp knife in Embodiment 3 of the present invention.

FIG. 14 is a sectional view in a B-B direction in FIG. 13.

FIG. 15 is a schematic diagram of straight outline cutting of an ultrasonic cutting knife for honeycomb core curve outline machining in Embodiment 3 of the present invention.

FIG. 16 is a flow block diagram of an ultrasonic cutting method for a honeycomb core sinking groove structure in Embodiment 4 of the present invention and a corresponding flow schematic diagram.

FIG. 17 is a flow block diagram of an ultrasonic cutting method for a honeycomb core lug boss structure in Embodiment 5 of the present invention and a corresponding flow schematic diagram.

### DESCRIPTION OF THE EMBODIMENTS

To make the objective, technical solutions and advantages of the embodiments of the present invention more clearly, the technical solutions in the embodiments of the present invention will be clearly and completely described hereinafter with the accompanying drawings in the embodiments of the present invention. It is apparent that the described embodiments are only part of the embodiments of the present invention, not all of the embodiments. All other embodiments obtained by a person of ordinary skill in the art based on the embodiments of the present invention without creative efforts shall pertain to the protection scope of the present invention.

### Embodiment 1

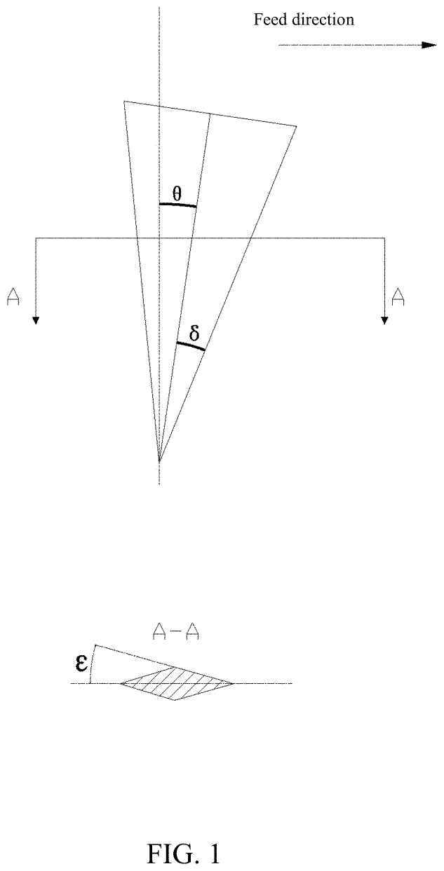

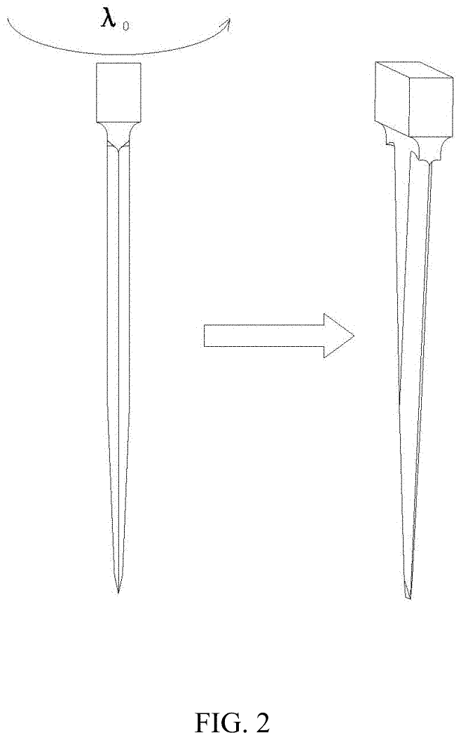

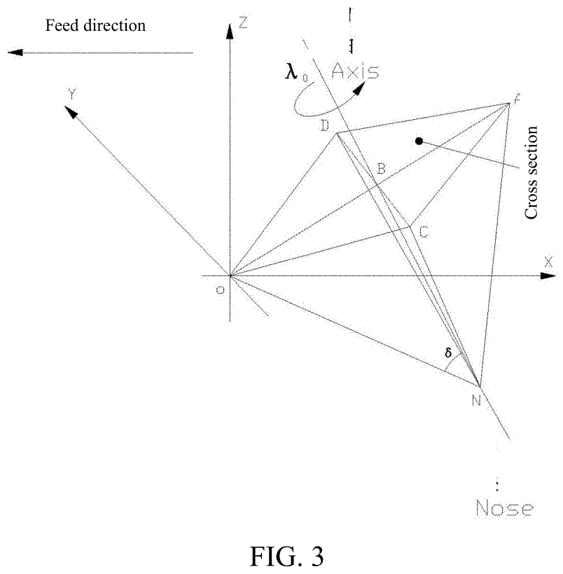

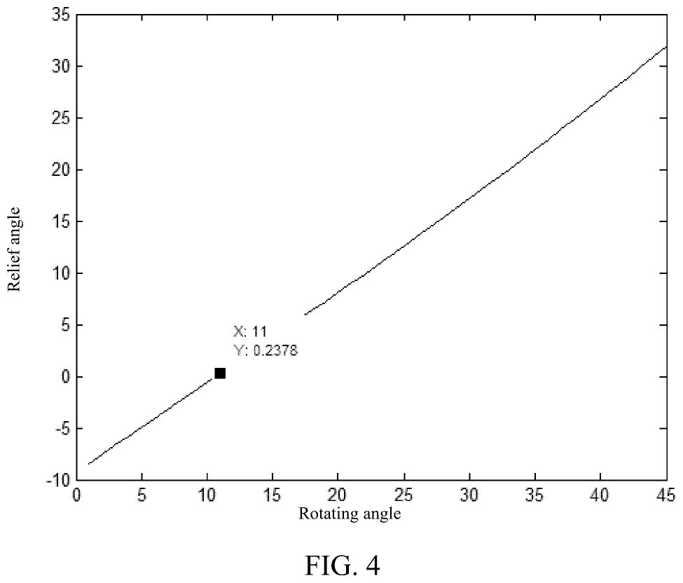

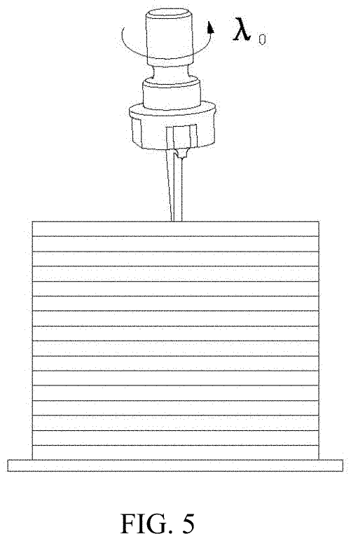

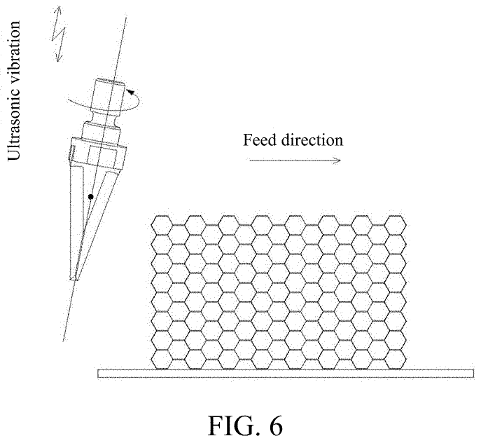

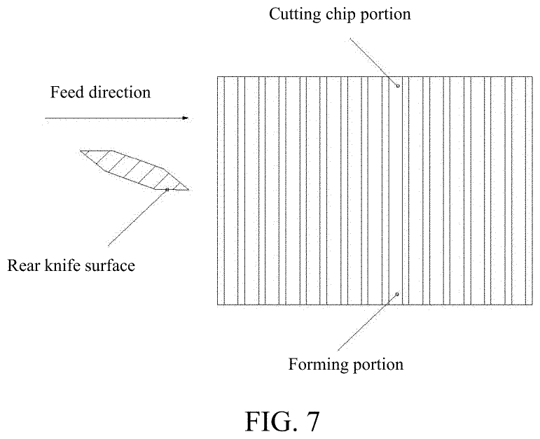

As shown in FIG. 1 to FIG. 9, an ultrasonic cutting method employing a straight-blade sharp knife includes the following steps:

S1, the parameters of the straight-blade sharp knife are measured.

S2, the straight-blade sharp knife initially rotates around an axis thereof, such that a rear knife surface of the straight-blade sharp knife is attached to or is away from a machined surface, and ultrasonic vibration cutting is performed on a material according to a machining track.

S3, quality detection is performed on the machined material surface obtained by the ultrasonic vibration cutting, the machining is completed if the surface passes the detection, and step S4 is executed if the surface does not pass the detection.

S4, an amount of rotation (a rotating angle) of the straight-blade sharp knife during initial rotation around the axis thereof is further increased, the ultrasonic vibration cutting is performed on the material according to the machining track, and step S3 is performed.

The parameters of the straight-blade sharp knife include a half-wedge angle ε, a half-nose angle δ and a knife rake angle θ.

In the embodiment, the half-wedge angle ε=12.5°, the half-nose angle δ=10.5°, and the knife rake angle θ=30°.

In step S2, before the straight-blade sharp knife initially rotates around the axis thereof, a knife rotating angle λ₀ rotated by the straight-blade sharp knife is calculated, with a following calculation process:

In a space rectangular coordinate system, an equivalent relief angle of the straight-blade sharp knife is given by using a rotation matrix method, the equivalent relief angle of the straight-blade sharp knife being a function regarding the knife rake angle θ, the half-wedge angle ε, the half-nose angle δ and the knife rotating angle λ; and in a case where the knife rake angle θ, the half-wedge angle ε and the half-nose angle δ are determined, the knife rotating angle λ, i.e., the knife rotating angle λ₀ rotated by the straight-blade sharp knife, when the equivalent relief angle of the straight-blade sharp knife is 0° is solved by using mathematical software MATLAB, λ₀=11°.

In step S1, the parameters of the straight-blade sharp knife are measured by a photoelectric sensor.

An angle between the rear knife surface of the straight-blade sharp knife and the machined surface is constant during the ultrasonic vibration cutting performed on the material according to the machining track.

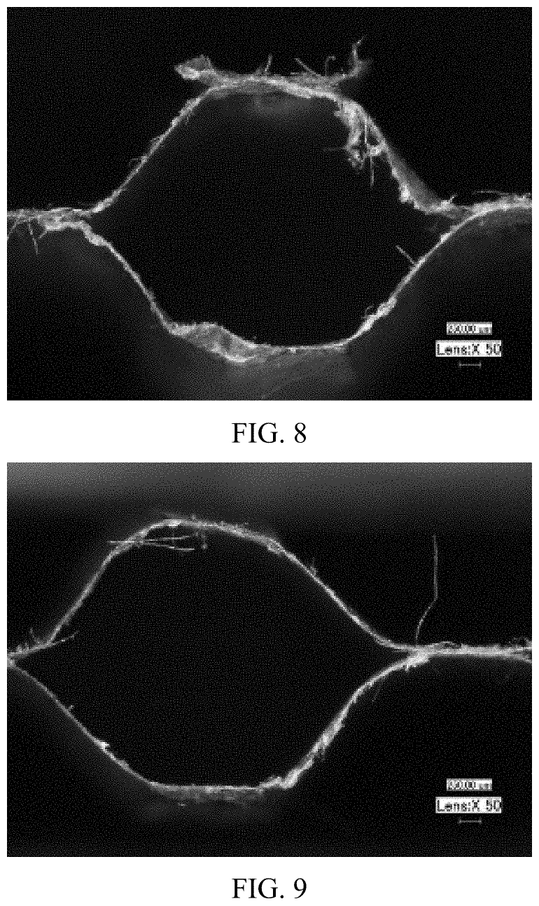

As can be seen from FIG. 8 and FIG. 9, the specific implementation manner may improve the machining quality of the flexible plastic material.

### Embodiment 2

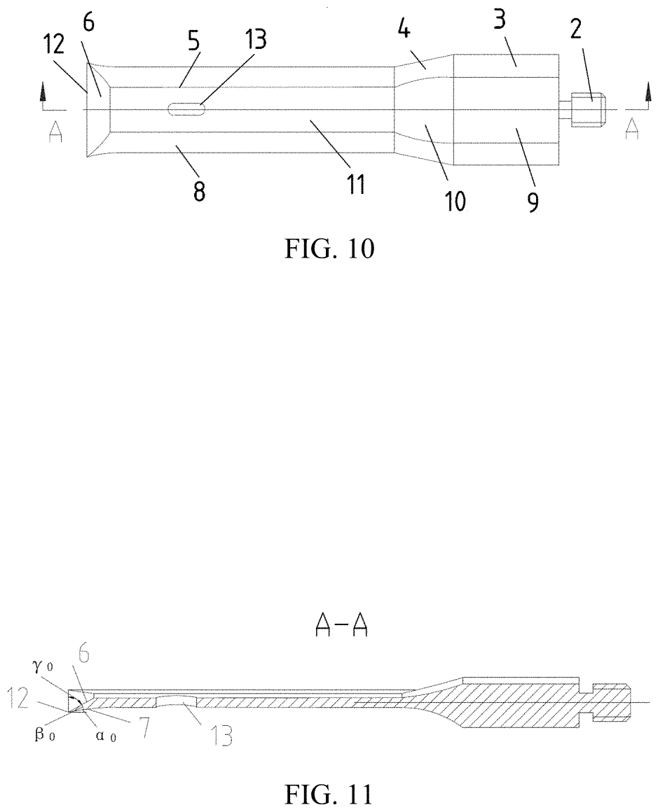

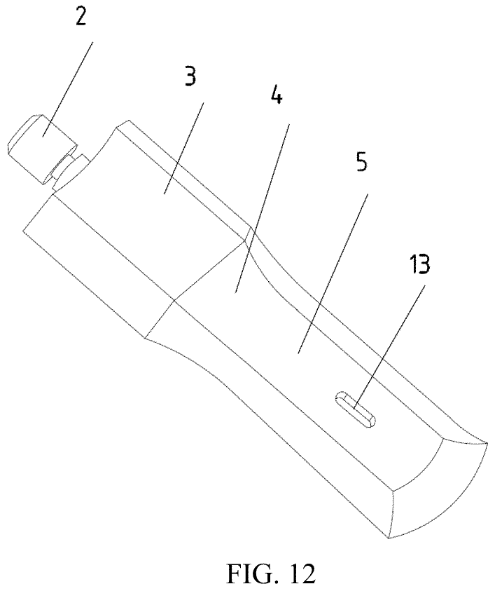

As shown in FIG. 10 to FIG. 12, an ultrasonic cutting method employing a straight-blade sharp knife is configured to machine a curve outline of a honeycomb core. Unlike the ultrasonic cutting method employing the straight-blade sharp knife in Embodiment 1, the straight-blade sharp knife 1 includes a threaded segment 2, a stiffness reinforcement block 3, a trapezoid table-like transition block 4 and a flaky open knife body 5 that are connected sequentially, and axes of the threaded segment 2, the stiffness reinforcement block 3, the trapezoid table-like transition block 4 and the flaky open knife body 5 are all located on the axis of the straight-blade sharp knife 1.

A big end of the trapezoid table-like transition block 4 is connected to a front end of the stiffness reinforcement block 3, the big end of the trapezoid table-like transition block 4 is consistent with the front end of the stiffness reinforcement block 3 in size, a small end of the trapezoid table-like transition block 4 is connected to a rear end of the flaky open knife body 5, the small end of the trapezoid table-like transition block 4 is consistent with the rear end of the flaky open knife body 5 in size, and an outer wall located between the big end of the trapezoid table-like transition block 4 and the small end of the trapezoid table-like transition block 4 is in arc transition from the big end of the trapezoid table-like transition block 4 to the small end of the trapezoid table-like transition block 4.

An outer surface of the flaky open knife body 5 is an arc surface, the front end of the flaky open knife body 5 is provided with a cutting arc bottom blade constituted by a sector-ring arc front knife surface 6 and a fan-ring arc rear knife surface 7, the cutting arc bottom blade tilts to the outer surface of the flaky open knife body 5, and two sides of the flaky open knife body 5 are respectively provided with a side blade 8 extending from a rear end of the flaky open knife body 5 to the cutting arc bottom blade; and the outer surface of the flaky open knife body 5 is the rear knife surface of the straight-blade sharp knife 1.

A guide groove extending from a rear end of the stiffness reinforcement block 3 to the cutting arc bottom blade is provided on an inner surface of the straight-blade sharp knife 1, the guide groove includes a stiffness reinforcement block guide groove 9 located on an inner surface of the stiffness reinforcement block 3, a trapezoid table-like transition block guide groove 10 located on an inner surface of the trapezoid table-like transition block 4 and an arc knife body guide groove 11 located on an inner surface of the flaky open knife body 5, and the arc knife body guide groove 11 corresponds to the outer surface of the flaky open knife body 5.

An arc where a nose 12 of the cutting arc bottom knife is located has a central angle of greater than 0° and smaller than 360°.

A front angle γ₀ of the cutting arc bottom blade is 45-85°, a relief angle α₀ of the cutting arc bottom blade is 0-15°, and a wedge angle β₀ of the cutting arc bottom blade is 15-30°.

An axial kidney groove 13 is provided along an axial direction of the straight-blade sharp knife 1 and on a bottom proximal to the cutting arc bottom blade in the arc knife body guide groove 11, and the axial kidney groove 13 penetrates through the flaky open knife body 5.

A width of the flaky open knife body 5 is designed according to a size of a honeycomb core grid, and a length of the flaky open knife body 5 is greater than a depth of a honeycomb core in need of being cut.

After the straight-blade sharp knife 1 is fed along the axis to ultrasonically cut the honeycomb core, a cutting seam kept by the flaky open knife body 5 on the honeycomb core is 0.5-5 mm wide.

The straight-blade sharp knife 1 is made of hard alloy or high-speed steel, and the cutting arc bottom blade and the side blade 8 are subjected to coating treatment.

### Embodiment 3

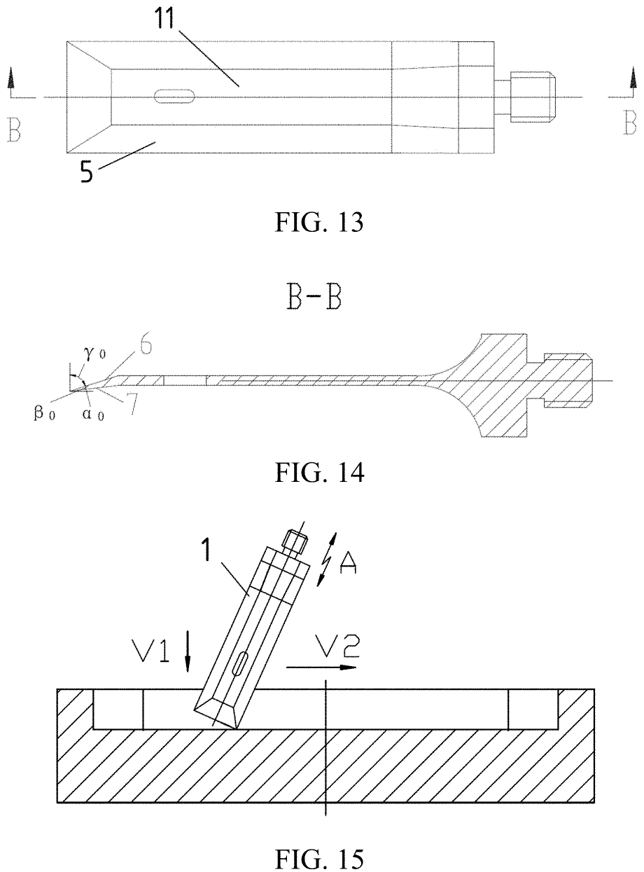

As shown in FIG. 13 to FIG. 15, an ultrasonic cutting method employing a straight-blade sharp knife differs from the ultrasonic cutting method employing the straight-blade sharp knife in Embodiment 2 in that the fan-ring arc front knife surface 6, the fan-ring arc rear knife surface 7, the outer surface of the flaky open knife body 5 and the arc knife body guide groove 11 tend to be a plane.

As shown in FIG. 15, when the axis of the straight-blade sharp knife is not perpendicular to the bottom of the sinking groove, the approximately plane straight-blade sharp knife 1 further has a linear ultrasonic cutting function: the knife is fed perpendicularly along the axis of the honeycomb grid to cut to an internal specified depth of the honeycomb core material, and is fed along a horizontal direction to linearly cut the honeycomb core material under the axial ultrasonic action.

### Embodiment 4

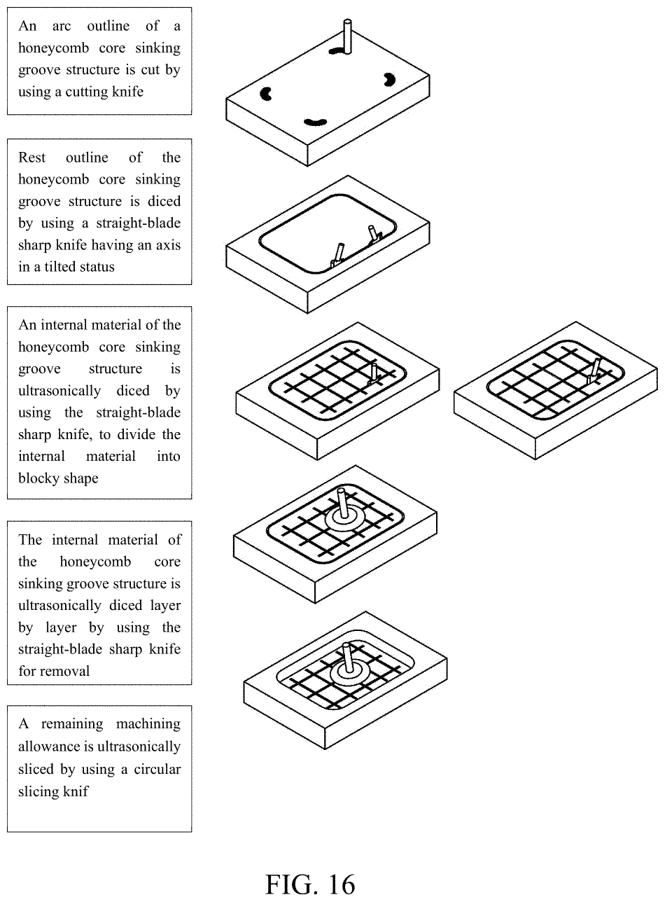

As shown in FIG. 16, an ultrasonic cutting method for a honeycomb core sinking groove structure includes the following steps:

A1, outline forming: an outline of the honeycomb core sinking groove structure is cut by using a cutting knife and a straight-blade sharp knife under an action of ultrasonic vibration.

An axis of the straight-blade sharp knife is in a tilted status, a fillet of the honeycomb core sinking groove structure is cut by using the cutting knife, and then a sidewall of the honeycomb core sinking groove structure tangent with the fillet is ultrasonically diced along a track by using the straight-blade sharp knife having the axis in the tilted status, the ultrasonic dicing method of the straight-blade sharp knife being the ultrasonic cutting method employing the straight-blade sharp knife in Embodiment 1.

A2, dicing division: in combination with a diameter of a circular slicing knife and an edge length of a to-be-machined honeycomb core, according to a shape and a size of the honeycomb core sinking groove structure, an internal material of the honeycomb core sinking groove structure is ultrasonically diced by using the straight-blade sharp knife according to a dicing track, to divide the internal material into a blocky cutting chip.

The dicing track includes a plurality of transverse and longitudinal dicing lines.

The axis of the straight-blade sharp knife is in a perpendicular status, and a cutting allowance in a horizontal direction is kept between two ends of the dicing line and corresponding outline of the honeycomb core sinking groove structure; or the axis of the straight-blade sharp knife is in the tilted status, a starting end of the dicing line is located on the corresponding outline of the honeycomb core sinking groove structure, a cutting allowance in a horizontal direction is kept between the other end of the dicing line and the corresponding outline of the honeycomb core sinking groove structure, the straight-blade sharp knife performs perpendicular cutting on the starting end of the dicing line, and is stopped and lifted when dicing to the other end of the dicing line.

The horizontal cutting allowance is smaller than or equal to the diameter of the circular slicing knife.

A size of a single blocky or strip-shaped cutting chip is greater than the edge length a of the to-be-machined honeycomb core and smaller than the diameter D of the circular slicing knife; and a perpendicular machining allowance of 0.1-10 mm is preserved between a dicing depth of the straight-blade sharp knife and the bottom of the honeycomb core sinking groove structure.

A3, removal for the internal material of the honeycomb core sinking groove structure 1: the internal material of the honeycomb core sinking groove structure is ultrasonically diced layer by layer by using the circular slicing knife for removal.

The circular slicing knife vibrates ultrasonically while rotating, thus slicing the internal material of the honeycomb core sinking groove structure layer by layer from the inside out for removal.

Slicing each layer for removal includes the following steps:

The circular slicing knife cuts the internal material of the honeycomb core sinking groove structure along a spiral track; and when cutting to a specified depth of each layer, ultrasonic cutting is performed along a plane cutting track; the internal material of the honeycomb core sinking groove structure is removed in the form of the strip-shaped or blocky cutting chip, thus completing the cutting of the internal material of the honeycomb core sinking groove structure on the layer; and the process is circulated till rest internal material of the honeycomb core sinking groove structure 1 is removed.

A4, precision machining for a bottom of the honeycomb core sinking groove structure: a remaining machining allowance is ultrasonically sliced by using the circular slicing knife to obtain the high-quality bottom of the honeycomb core sinking groove structure, thus completing the machining of the honeycomb core sinking groove structure.

### Embodiment 5

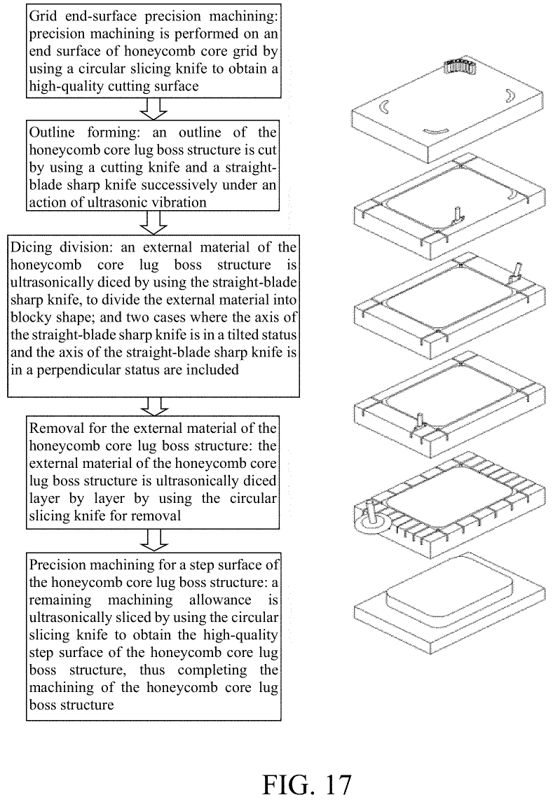

As shown in FIG. 17, an ultrasonic cutting method for a honeycomb core lug boss structure includes the following steps:

B1, grid end-surface precision machining: precision machining is performed on an end surface of a honeycomb core grid by using a circular slicing knife to obtain a high-quality cutting surface.

B2, outline forming: an outline of the honeycomb core lug boss structure is cut by using a cutting knife and a straight-blade sharp knife successively under an action of ultrasonic vibration.

A fillet outline of the honeycomb core lug boss structure is cut first under the action of the ultrasonic vibration by using the cutting knife, and then under the action of the ultrasonic vibration, the straight-blade sharp knife is used for dicing along the outline of the honeycomb core lug boss structure to dice a “#”-shaped outline by four times of cutting. The dicing method of the straight-blade sharp knife is the ultrasonic cutting method employing the straight-blade sharp knife in Embodiment 1.

B3, dicing division: in combination with a radius of the circular slicing knife and an edge length of a to-be-machined honeycomb core grid, according to a shape and a size of the honeycomb core lug boss structure, an external material of the honeycomb core lug boss structure is ultrasonically diced by using the straight-blade sharp knife according to a dicing track, to divide the external material into blocky shape or strip shape.

The dicing track includes a plurality of transverse and longitudinal dicing lines.

An axis of the straight-blade sharp knife is in a tilted status, and the straight-blade sharp knife tilts to an external direction of the outline of the honeycomb core lug boss structure, thus ensuring that a blade of the straight-blade sharp knife is perpendicular to an end surface of the to-be-machined honeycomb core grid, and is fed downwards to a specified depth.

Or during the dicing division, the axis of the straight-blade sharp knife is in a perpendicular status, and when the straight-blade sharp knife dices to be proximal to the outline of the honeycomb core lug boss structure, a horizontal cutting allowance is kept, the horizontal cutting allowance being a half of a width of the straight-blade sharp knife.

A size of a single blocky or strip-shaped cutting chip is greater than the edge length a of the to-be-machined honeycomb core grid and smaller than the radius R of the circular slicing knife; and a perpendicular machining allowance of 0.1-10 mm is preserved between a dicing depth of the straight-blade sharp knife and the step surface of the honeycomb core lug boss structure.

B4, removal for the external material of the honeycomb core lug boss structure: the external material of the honeycomb core lug boss structure is ultrasonically diced layer by layer by using the circular slicing knife for removal.

The circular slicing knife vibrates ultrasonically while rotating, thus slicing the external material of the honeycomb core lug boss structure layer by layer from the inside out for removal.

Slicing each layer for removal includes the following steps:

An appropriate slicing depth is selected, the circular slicing knife slicing from an outermost end of the external material of the honeycomb core lug boss structure, ultrasonic cutting is performed along the plane cutting track from the outside in, and it is ensured that a machining allowance of 2-5 mm is kept.

B5, precision machining for a step surface of the honeycomb core lug boss structure: a remaining machining allowance is ultrasonically sliced by using the circular slicing knife to obtain the high-quality step surface of the honeycomb core lug boss structure, thus completing the machining of the honeycomb core lug boss structure.

At last, it is to be noted that: the above embodiments are merely used to describe the technical solutions of the present invention, rather than to limit the present invention. Although the present invention is described in detail with reference to the foregoing embodiments, a person of ordinary skill in the art should understand that the technical solutions in the foregoing embodiments may still be modified or equivalent replacements are made to a part or all of technical features. Those modifications or replacements do not make the essence of the corresponding technical solutions depart from the scope of the technical solutions of the embodiments of the present invention.

1. An ultrasonic cutting method employing a straight-blade sharp knife, comprising the following steps:
S1, measuring parameters of the straight-blade sharp knife;
S2, initially rotating, by the straight-blade sharp knife, around an axis thereof, such that a rear knife surface of the straight-blade sharp knife is attached to or is away from a machined surface, and performing ultrasonic vibration cutting on a material according to a machining track;
S3, performing quality detection on the machined material surface obtained by the ultrasonic vibration cutting, completing the machining if the surface passes the detection, and performing step S4 if the surface does not pass the detection; and
S4, further increasing an amount of rotation of the straight-blade sharp knife during initial rotation around the axis thereof, performing the ultrasonic vibration cutting on the material according to the machining track, and performing step S3.

2. The method according to claim 1, wherein the parameters of the straight-blade sharp knife comprise a half-wedge angle ε, a half-nose angle δ and a knife rake angle θ; and
in step S2, before initially rotating, by the straight-blade sharp knife, around the axis thereof, calculating a knife rotating angle λ₀ rotated by the straight-blade sharp knife, with a following calculation process:
in a space rectangular coordinate system, giving an equivalent relief angle of the straight-blade sharp knife by using a rotation matrix method, the equivalent relief angle of the straight-blade sharp knife being a function regarding the knife rake angle θ, the half-wedge angle ε, the half-nose angle δ and the knife rotating angle λ; and in a case where the knife rake angle θ, the half-wedge angle c and the half-nose angle δ are determined, by using mathematical software Matrix Laboratory (MATLAB), solving the knife rotating angle λ, i.e., the knife rotating angle λ₀ rotated by the straight-blade sharp knife, when the equivalent relief angle of the straight-blade sharp knife is 0°.

3. The method according to claim 1, wherein
in step S1, the parameters of the straight-blade sharp knife are measured by a photoelectric sensor; and
in step S2, an angle between the rear knife surface of the straight-blade sharp knife and the machined surface is constant during the ultrasonic vibration cutting performed on the material according to the machining track.

4. The method according to claim 1, wherein the straight-blade sharp knife comprises a threaded segment, a stiffness reinforcement block, a trapezoid table-like transition block and a flaky open knife body that are connected sequentially, and axes of the threaded segment, the stiffness reinforcement block, the trapezoid table-like transition block and the flaky open knife body are all located on the axis of the straight-blade sharp knife;
a big end of the trapezoid table-like transition block is connected to a front end of the stiffness reinforcement block, the big end of the trapezoid table-like transition block being consistent with the front end of the stiffness reinforcement block in size; a small end of the trapezoid table-like transition block is connected to a rear end of the flaky open knife body, the small end of the trapezoid table-like transition block being consistent with the rear end of the flaky open knife body in size; and an outer wall located between the big end of the trapezoid table-like transition block and the small end of the trapezoid table-like transition block is in arc transition from the big end of the trapezoid table-like transition block to the small end of the trapezoid table-like transition block; and
an outer surface of the flaky open knife body is an arc surface, the front end of the flaky open knife body is provided with a cutting arc bottom blade constituted by a sector-ring arc front knife surface and a sector-ring arc rear knife surface, the cutting arc bottom blade tilts to the outer surface of the flaky open knife body, and two sides of the flaky open knife body are respectively provided with a side blade extending from a rear end of the flaky open knife body to the cutting arc bottom blade; and the outer surface of the flaky open knife body is the rear knife surface of the straight-blade sharp knife; and
a guide groove extending from a rear end of the stiffness reinforcement block to the cutting arc bottom blade is provided on an inner surface of the straight-blade sharp knife, the guide groove comprising a stiffness reinforcement block guide groove located on an inner surface of the stiffness reinforcement block, a trapezoid table-like transition block guide groove located on an inner surface of the trapezoid table-like transition block and an arc knife body guide groove located on an inner surface of the flaky open knife body, and the arc knife body guide groove corresponding to the outer surface of the flaky open knife body.

5. The method according to claim 4, wherein when the straight-blade sharp knife is configured to machine a curve outline of a honeycomb core, an arc where a nose of the cutting arc bottom blade is located has a central angle of greater than 0° and smaller than 360°; a front angle of the cutting arc bottom blade is 45-85°, a relief angle of the cutting arc bottom blade is 0-15°, and a wedge angle of the cutting arc bottom blade is 5-30°; an axial kidney-shaped groove is provided along an axial direction of the straight-blade sharp knife and on a bottom proximal to the cutting arc bottom blade in the arc knife body guide groove, and the axial kidney-shaped groove penetrates through the flaky open knife body; a width of the flaky open knife body is designed according to a size of a honeycomb core grid, and a length of the flaky open knife body is greater than a depth of a honeycomb core in need of being cut; and after the straight-blade sharp knife is fed along the axis to ultrasonically cut the honeycomb core, a cutting seam kept by the flaky open knife body on the honeycomb core is 0.5-5 mm wide; and the straight-blade sharp knife is made of hard alloy or high-speed steel, and the cutting arc bottom blade and the side blade are subjected to coating treatment.

6. An ultrasonic cutting method for honeycomb core sinking groove structure, comprising the following steps:
A1, outline forming: cutting, by using a slotting knife and a straight-blade sharp knife, an outline of the honeycomb core sinking groove structure under an action of ultrasonic vibration, an ultrasonic dicing method of the straight-blade sharp knife being the ultrasonic cutting method employing the straight-blade sharp knife according to claim 1;
A2, dicing division: in combination with a diameter of a circular slicing knife and an edge length of a to-be-machined honeycomb core, according to a shape and a size of the honeycomb core sinking groove structure, ultrasonically dicing an internal material of the honeycomb core sinking groove structure by using the straight-blade sharp knife according to a dicing track, to divide the internal material into blocky or strip-shaped cutting chip;
A3, removal for the internal material of the honeycomb core sinking groove structure: ultrasonically dicing the internal material of the honeycomb core sinking groove structure layer by layer by using the circular slicing knife for removal; and
A4, precision machining for a bottom of the honeycomb core sinking groove structure: ultrasonically slicing a remaining machining allowance by using the circular slicing knife to obtain the high-quality bottom of the honeycomb core sinking groove structure, thus completing the machining of the honeycomb core sinking groove structure.

7. The ultrasonic cutting method for the honeycomb core sinking groove structure according to claim 6, wherein during the outline forming, an axis of the straight-blade sharp knife is in a tilted status, an arc outline of the honeycomb core sinking groove structure is machined through plunge milling by using the slotting knife, and then the rest outline of the honeycomb core sinking groove structure is ultrasonically diced by using the straight-blade sharp knife having the axis in the tilted status; the dicing track comprises a plurality of transverse and longitudinal dicing lines; and during the dicing division, the axis of the straight-blade sharp knife is in a perpendicular status, and a cutting allowance in a horizontal direction is respectively kept between two ends of the dicing line and the corresponding outline of the honeycomb core sinking groove structure;
or during the dicing division, the axis of the straight-blade sharp knife is in the tilted status, a starting end of the dicing line is located on the corresponding outline of the honeycomb core sinking groove structure, a cutting allowance in a horizontal direction is kept between the other end of the dicing line and the corresponding outline of the honeycomb core sinking groove structure, the straight-blade sharp knife performs perpendicular cutting on the starting end of the dicing line, and is stopped and lifted when dicing to the other end of the dicing line; and the horizontal cutting allowance is smaller than or equal to the diameter of the circular slicing knife;
in step A2, a size of a single blocky or strip-shaped cutting chip is greater than the edge length a of the to-be-machined honeycomb core and smaller than the diameter D of the circular slicing knife; and a perpendicular machining allowance of 0.1-10 mm is preserved between a dicing depth of the straight-blade sharp knife and the bottom of the honeycomb core sinking groove structure; during the removal for the internal material of the honeycomb core sinking groove structure, the circular slicing knife vibrates ultrasonically while rotating, thus slicing the internal material of the honeycomb core sinking groove structure layer by layer from the inside out for removal; and
slicing each layer for removal comprises the following steps:
cutting, by the circular slicing knife, the internal material of the honeycomb core sinking groove structure along a spiral track; and when cutting to a specified depth of each layer, performing ultrasonic cutting along a plane cutting track; and in step A4, ultrasonically slicing the remaining machining allowance by using the circular slicing knife refers to that the remaining machining allowance is sliced layer by layer for removal.

8. An ultrasonic cutting method for a honeycomb core lug boss structure, comprising the following steps:
B1, grid end-surface precision machining: performing precision machining on an end surface of a honeycomb core grid by using a circular slicing knife to obtain a high-quality cutting surface;
B2, outline forming: machining, by using a slotting knife and a straight-blade sharp knife successively, an outline of the honeycomb core lug boss structure under an action of ultrasonic vibration, a dicing method of the straight-blade sharp knife being the ultrasonic cutting method employing the straight-blade sharp knife according to claim 1;
B3, dicing division: in combination with a radius of the circular slicing knife and an edge length of a to-be-machined honeycomb core grid, according to a shape and a size of the honeycomb core lug boss structure, ultrasonically dicing an external material of the honeycomb core lug boss structure by using the straight-blade sharp knife according to a dicing track, to divide the external material into blocky shape or strip shape;
B4, removal for the external material of the honeycomb core lug boss structure: ultrasonically dicing the external material of the honeycomb core lug boss structure layer by layer by using the circular slicing knife for removal; and
B5, precision machining for a step surface of the honeycomb core lug boss structure: ultrasonically slicing a remaining machining allowance by using the circular slicing knife to obtain the high-quality step surface of the honeycomb core lug boss structure, thus completing the machining of the honeycomb core lug boss structure.

9. The ultrasonic cutting method for the honeycomb core lug boss structure according to claim 8, wherein during the outline forming, a fillet outline of the honeycomb core lug boss structure is cut first under the action of the ultrasonic vibration by using the slotting knife, and then under the action of the ultrasonic vibration, the straight-blade sharp knife is used for dicing along the outline of the honeycomb core lug boss structure to dice a “#”-shaped outline by four times of cutting; the dicing track comprises a plurality of transverse and longitudinal dicing lines; and during the dicing division, an axis of the straight-blade sharp knife is in a tilted status, and the straight-blade sharp knife tilts to an external direction of the outline of the honeycomb core lug boss structure, thus ensuring that a blade of the straight-blade sharp knife is perpendicular to an end surface of the to-be-machined honeycomb core grid, and is fed downwards to a specified depth;
or during the dicing division, the axis of the straight-blade sharp knife is in a perpendicular status, and when the straight-blade sharp knife dices to be proximal to the outline of the honeycomb core lug boss structure, a horizontal cutting allowance is kept, the horizontal cutting allowance being more than or equal to a half of a width of the straight-blade sharp knife;
in step B3, a size of a single blocky or strip-shaped cutting chip is greater than the edge length a of the to-be-machined honeycomb core grid and smaller than the radius R of the circular slicing knife; a perpendicular machining allowance of 0.1-10 mm is preserved between a dicing depth of the straight-blade sharp knife and the step surface of the honeycomb core lug boss structure; and during the removal for the external material of the honeycomb core lug boss structure, the circular slicing knife vibrates ultrasonically while rotating, thus slicing the external material of the honeycomb core lug boss structure layer by layer from the outside in for removal; and
slicing each layer for removal comprises the following steps:
selecting an appropriate slicing depth, the circular slicing knife slicing from an outermost end of the external material of the honeycomb core lug boss structure, performing ultrasonic cutting along the plane cutting track from the outside in, and ensuring that a machining allowance of 2-5 mm is kept; and in step B4, ultrasonically slicing the remaining machining allowance by using the circular slicing knife refers to that the remaining machining allowance is sliced layer by layer for removal.
